(19) United States
(12) Patent Application Publication
(10) Pub. No.: US 2026/0072691 A1
(43) Pub. Date: Mar. 12, 2026

(54) INFORMATION PROCESSING APPARATUS, INFORMATION PROCESSING METHOD, AND COMPUTER PROGRAM PRODUCT

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Mikio HASHIMOTO, Bunkyo (JP); Koichi ETO, Kawasaki (JP); Yasuhiro FUKUJU, Yokohama (JP); Koji KITAYAMA, Kita (JP); Hirohisa KUSANO, Mitaka (JP); Kosuke IMAI, Fuchu (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/274,871

(22) Filed: Jul. 21, 2025

(30) Foreign Application Priority Data
Sep. 12, 2024 (JP) 2024-158205

(51) Int. Cl. G06F 9/38; G06F 21/55

(52) U.S. Cl. CPC G06F 9/3836; G06F 21/55

(57) ABSTRACT

A central processing unit (CPU) 20 of a micro controller unit (MCU) 10 (information processing apparatus) sequentially executes a first-partial program (Block J) and a second-partial program (Block K). The first-partial program causes the CPU 20 to perform redundancy execution of the first unique process associated with the first-partial program twice or more (Steps S202-S208 and S212-S218). Then, the first-partial program causes the CPU 20 to record each piece of output data output for each of first unique processes (unique processes J_0 and J_1) in each of the first data regions (data regions D0j and D1j) pre-allocated to each piece of output data, and permit execution of the second-partial program subsequently to the first-partial program (Step S238) when pieces of output data of the first unique process or digest values of the output data recorded in first data regions match (Steps S220 and S228).

### CROSS-REFERENCE TO RELATED APPLICATIONS

This application is based upon and claims the benefit of priority from Japanese Patent Application No. 2024-158205, filed on Sep. 12, 2024; the entire contents of which are incorporated herein by reference.

### FIELD

Embodiments described herein relate generally to an information processing apparatus, an information processing method, and a computer program product.

### BACKGROUND

Technologies for countermeasures against threats due to a fault injection attack are known. For example, a method of hardware (HW) redundancy such as a dual core lock system (DCLS) is known.

In the DCLS, since two originally necessary central processing unit (CPU) cores are mounted and a comparison operation is performed for each logical clock, there is a problem that the original CPUs and a logic circuit of a comparator are required, and an operating frequency is greatly reduced as compared with the case of a single CPU. For this reason, in the related art, it has been difficult to efficiently reduce vulnerability to the threat of the fault injection attack.

### BRIEF DESCRIPTION OF THE DRAWINGS

FIG. 1 is a schematic diagram of a micro controller unit (MCU) package of an embodiment;

FIG. 2 is a flowchart of an application example of the MCU package of the embodiment;

FIG. 3 is an explanatory diagram of a virtual instruction used in a central processing unit (CPU) of the embodiment;

FIG. 4 is a diagram illustrating a sequential execution structure of a partial program;

FIG. 5 is an explanatory diagram of a memory layout;

FIG. 6 is an explanatory diagram of a list of definition entries of a Memory Protection Unit;

FIG. 7A is a flowchart illustrating a flow of information processing;

FIG. 7B is a flowchart illustrating the flow of information processing;

FIG. 8A is an explanatory diagram of a related art;

FIG. 8B is an explanatory diagram of the related art;

FIG. 8C is an explanatory diagram of the related art;

FIG. 9 is an explanatory diagram of a memory layout;

FIG. 10A is a flowchart illustrating a flow of information processing;

FIG. 10B is a flowchart illustrating the flow of information processing;

FIG. 11 is a diagram illustrating a sequential execution structure of a partial program;

FIG. 12 is an explanatory diagram of a memory layout;

FIG. 13A is a flowchart illustrating a flow of information processing; and

FIG. 13B is a flowchart illustrating the flow of information processing.

### DETAILED DESCRIPTION

According to an embodiment, an information processing apparatus includes a central processing unit (CPU) configured to sequentially execute a first partial program and a second partial program. The first partial program causes the CPU to perform redundancy execution of a unique process associated with the first partial program twice or more and record each piece of output data that is output for each unique process in a first data region allocated in advance to the each piece of output data, and permit execution of the second partial program subsequently to the first partial program in a case where pieces of output data or digest values of the pieces of output data for the each unique process recorded in the first data regions match each other.

An object of the present disclosure is to provide an information processing apparatus, an information processing method, and a computer program product capable of efficiently reducing vulnerability to a threat of a fault injection attack.

Hereinafter, an information processing apparatus, an information processing method, and a computer program product according to the present embodiment will be described in detail with reference to the accompanying drawings. The present disclosure is not limited to the following embodiments.

Note that, in the following description of each embodiment, portions denoted by the same reference signs have substantially the same functions, and a description of overlapping portions will be omitted as appropriate.

### First Embodiment

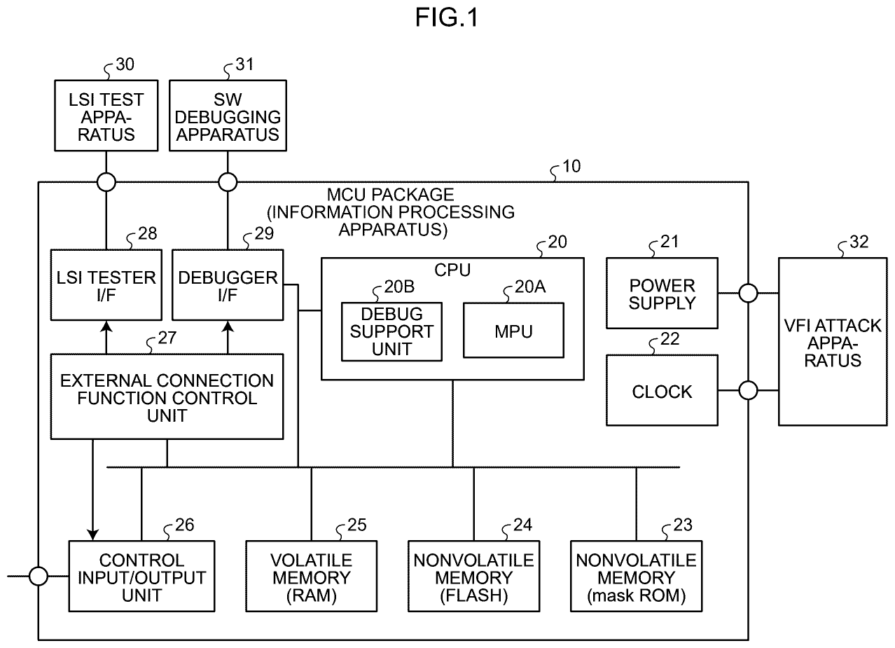

FIG. 1 is a schematic diagram of an example of a micro controller unit (MCU) package 10 of the present embodiment. Hereinafter, the MCU package 10 will be referred to as an MCU 10. The MCU 10 is an example of an information processing apparatus. That is, in the present embodiment, a case where an apparatus in which main logical functions of Internet of Things (IoT) devices are aggregated is used for the MCU of one chip as the information processing apparatus will be described as an example.

The MCU 10 of the present embodiment is an MCU 10 in which a countermeasure against a fault injection attack in software execution, particularly, a threat of voltage fault injection (VFI), which is a fault injection attack that can be executed without leaving a trail by an inexpensive apparatus, is enhanced by a software configuration utilizing an existing central processing unit (CPU) function with a configuration described in detail below.

The MCU 10 includes a CPU 20, a power supply 21, a clock 22, a nonvolatile memory 23, a nonvolatile memory 24, a volatile memory 25, a control input/output unit 26, an external connection function control unit 27, a large-scale integration (LSI) tester interface (I/F) 28, and a debugger I/F 29.

The CPU 20, the clock 22, the nonvolatile memory 23, the nonvolatile memory 24, the volatile memory 25, the control input/output unit 26, the external connection function control unit 27, the LSI tester I/F 28, and the debugger I/F 29 are communicably connected via a bus or the like.

The power supply 21 supplies power to each unit of the MCU 10. The clock 22 is a circuit that generates a clock signal inside the MCU 10. The nonvolatile memory 23, the nonvolatile memory 24, and the volatile memory 25 are examples of memories. The nonvolatile memory 23 is, for example, a mask read only memory (mask ROM). The nonvolatile memory 24 is, for example, a flash memory. The volatile memory 25 is, for example, a random access memory (RAM).

The control input/output unit 26 controls input/output with respect to an external apparatus. The external connection function control unit 27 controls connection with the external apparatus by controlling each of the LSI tester I/F 28, the debugger I/F 29, and the control input/output unit 26. The LSI tester I/F 28 is a communication I/F connected to an LSI test apparatus 30 which is an apparatus for executing an LSI test. The debugger I/F 29 is a communication I/F connected to a software (SW) debugging apparatus 31 which is a debugging apparatus for software (SW) of the MCU 10.

The CPU 20 executes various programs in the MCU 10. The CPU 20 is a microprocessor core consisting of major components such as arithmetic circuits, control circuits, and registers. In addition to these major components, the CPU 20 includes a Memory Protection Unit (MPU) 20A and a debug support unit 20B. The MPU 20A provides a function to limit the instructions and data access performed by the CPU 20 to specific address ranges. The MPU 20A contains multiple entries, each of which can hold multiple address ranges accessible by the programs executed by the CPU 20. In the embodiments described later, the MPU entries used to define the address ranges executable by instructions are called instruction MPUs, and the MPU entries used to define the address ranges accessible by data are called data MPUs. It should be noted that the terms instruction MPU and data MPU are based on their usage, and the MPU mechanism itself can be used for both without any issues. The debug support unit 20B is a functional unit that executes debugging processes upon requests from external debuggers.

The CPU 20 reads and executes partial programs stored in non-volatile memory 24 and the like. The details of the partial programs will be described later.

In FIG. 1, a case where the MCU 10 assumes a voltage fault injection (VFI) attack that is one of fault injection attacks by a VFI attack apparatus 32 which is an attacker is described. Specifically, in the present embodiment, an attack scenario in which the VFI attack apparatus 32 is connected to the MCU 10 via a power supply terminal of the power supply 21 or a clock terminal of the clock 22 and attacks the MCU 10 is assumed. The attack by the attacker is not limited to the assumption, and, for example, there may be an attack scenario in which the attacker intervenes in a setting process performed by the software on external connection functions of the LSI test apparatus 30, the SW debugging apparatus 31, and the control input/output unit 26, improperly validates an SW debugging function, an LSI test function, and the like, and then accesses the inside of the MCU 10 by using an SW debugging apparatus 41 or the like.

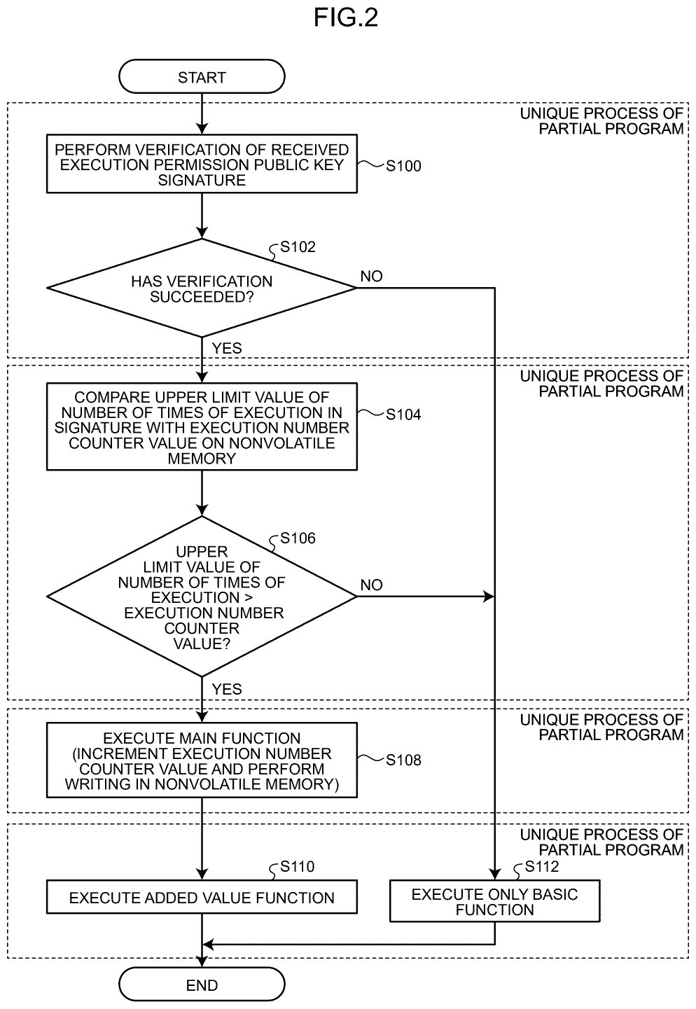

FIG. 2 is a flowchart of an application example of the MCU 10 of the present embodiment.

The CPU 20 of the MCU 10 reads a plurality of partial programs stored in the nonvolatile memory 24 and executes the partial programs in a predetermined order.

FIG. 2 illustrates a scene in which an upper limit value of the number of times of execution of the software for implementing an added value function is reported as an execution permission public key signature by a public key signature from an external information processing apparatus as an example. The software for implementing the added value function has been stored in advance in a built-in flash (nonvolatile memory 24) of the MCU 10, and the number of times of execution of the software is controlled according to the number of times of execution permission of the software reported from the external information processing apparatus. In addition, FIG. 2 illustrates an example in which the CPU 20 of the MCU 10 implements number control such that the number of times of execution of the added value function does not exceed the upper limit value of the number of times of execution based on an execution number counter value stored in the nonvolatile memory 24.

The CPU 20 verifies the received execution permission public key signature based on a verification public key held in advance by the partial program (Step S100). Then, the CPU 20 determines whether or not the verification in Step S100 has succeeded (Step S102).

In a case where it is determined in Step S102 that the verification has failed (Step S102: No), the processing proceeds to Step S112. In Step S112, the CPU 20 executes only a basic function (S112). In Step S112, the CPU 20 can acquire a new valid execution permission. Then, this routine ends.

In a case where it is determined in Step S102 that the verification has succeeded (Step S102: Yes), the processing proceeds to Step S104. In Step S104, the CPU 20 compares the upper limit value of the number of times of execution in the execution permission public key signature received in Step S100 with the execution number counter value stored in the nonvolatile memory 24 (Step S104). In a case where the upper limit value of the number of times of execution is equal to or smaller than the execution number counter value (Step S106: No), the CPU 20 proceeds to Step S112.

In a case where the upper limit value of the number of times of execution is larger than the execution number counter value (Step S106: Yes), the CPU 20 proceeds to Step S108.

In Step S108, the CPU 20 increments the execution number counter value and performs writing in the nonvolatile memory 24 by 1 (Step S108).

In a low-cost MCU, a flash memory is often used as the nonvolatile memory 24. In the flash memory, reading can be performed in units of words similarly to the RAM. However, in the flash memory, rewriting a certain value requires temporarily erasing the entire memory page storing the value. Therefore, in a case where other data is included in the page, the CPU 20 executes processing of incrementing only the execution number counter value after backing up the entire data before erasing the page. In addition, in the flash memory, wear leveling of extending a life of the flash memory may be performed by equalizing the numbers of times of rewriting in a plurality of pages.

Next, the CPU 20 executes the added value function (Step S110). The added value function is predetermined processing. Then, this routine ends.

In the example illustrated in FIG. 2, Steps S100 to S102 correspond to a unique process of one partial program, Steps S104 to S106 correspond to a unique process of one partial program, and Steps S110 to S112 correspond to a unique process of one partial program. Details of the unique processes are described below.

Here, vulnerability is caused from the viewpoint of correctly managing the number of times of execution of the added value function even when any processing of Step S100 to Step S110 is skipped. For example, the fault injection attack may be performed on the MCU 10 after the execution permission public key signature verification processing of Step S100 is executed, and comparison processing of Step S104 may be executed without executing verification success determination processing of Step S102. In this case, there is a possibility that the added value function in Step S110 is improperly executed.

In addition, for example, even in a case where the steps of processing of Steps S100 to S106 are correctly executed, when the processing of incrementing the execution number counter value in Step S108 is skipped due to the fault injection attack, it is difficult for the CPU 20 to accurately manage the execution number counter value.

In addition, for example, even in a case where the steps of processing of Steps S100 to S106 are correctly executed, when increment by a value of 2 or more is performed in the processing of incrementing the execution number counter value in Step S108 due to the fault injection attack, it is difficult for the CPU 20 to accurately manage the execution number counter value.

Therefore, the CPU 20 of the MCU 10 of the present embodiment sequentially executes a first partial program and a second partial program. The first partial program causes the CPU 20 to perform redundancy execution of a unique process associated with the first partial program twice or more, and record each piece of output data that is output for each unique process in a first data region allocated in advance to each piece of output data. Then, in a case where the pieces of the output data or digest values of the pieces the output data for each unique process recorded in the first data regions match, execution of the second partial program to be executed subsequently to the first partial program is permitted.

By the CPU 20 executing the processing, it is possible to efficiently reduce the vulnerability to a threat of the fault injection attack.

The first partial program and the second partial program are examples of the partial programs stored in the nonvolatile memory 24. In the present embodiment, an execution order of the plurality of partial programs stored in the nonvolatile memory 24 is predetermined. The first partial program is a partial program executed before the second partial program. The second partial program is a partial program executed subsequently to the first partial program. Therefore, each of the plurality of partial programs stored in the nonvolatile memory 24 can be each of the first partial program and the second partial program depending on an execution timing and the execution order. That is, the partial program that is being executed by the CPU 20 functions as the first partial program, and another partial program to be executed subsequently to the partial program that is being executed functions as the second partial program.

The unique process is a unique process associated with each partial program. The unique process is a program lacking a fault injection attack countermeasure, and is a program that can be called from each of the partial programs such as the first partial program and the second partial program.

Specifically, as described above, in the example illustrated in FIG. 2, the processing of Step S100 corresponds to the unique process of the partial program in steps S100 to S102, the processing of Step S104 corresponds to the unique process of the partial program in Steps S104 to S106, and Steps S110 and S112 correspond to the unique process of the partial program. The unique process of the first partial program corresponds to first unique process, and the unique process of the second partial program corresponds to second unique process.

Processing executed by the MCU 10 of the present embodiment will be described in detail.

The fault injection attack on the MCU 10 of the present embodiment acts on execution of a machine language instruction. In the present embodiment, a fault injection attack on the MCU 10 and a countermeasure will be described in detail based on a configuration of a virtual instruction.

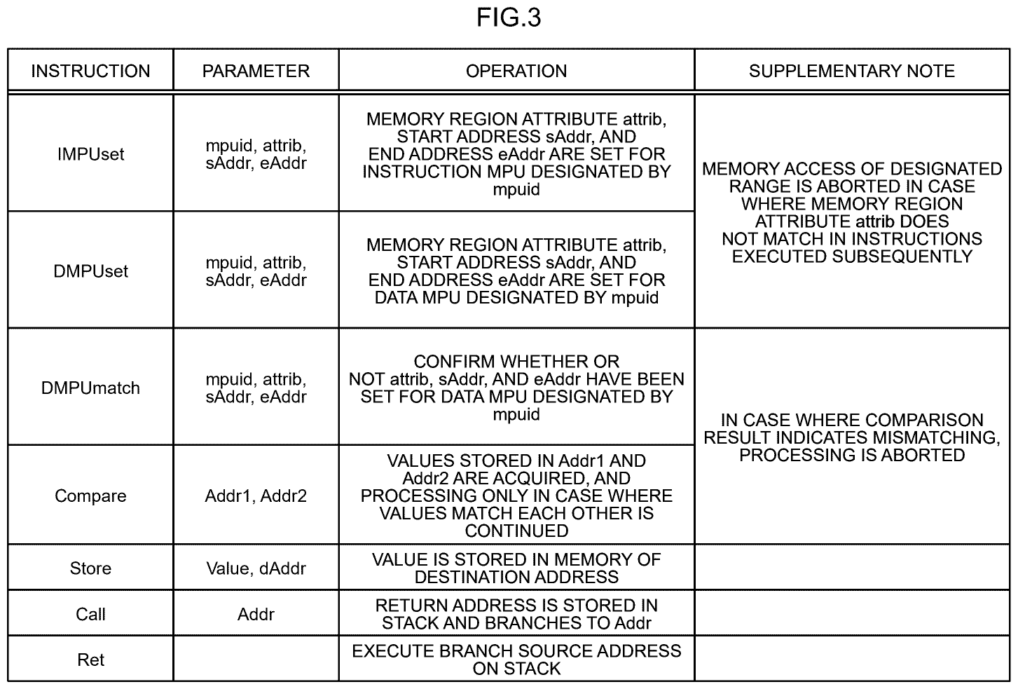

FIG. 3 is an explanatory diagram of an example of the virtual instruction used in the CPU 20 of the present embodiment. As the virtual instruction used in the present embodiment, only seven types of virtual instructions directly related to the MCU 10 of the present embodiment are defined from the viewpoint of generalization and simplification of instruction sets varying depending on a CPU architecture.

In the present embodiment, a case where an instruction MPU is aborted by instruction execution or data reference from the viewpoint of the simplification is described. In the present embodiment, a case where immediate processing is aborted in a case where an error of a data MPU has occurred is described. It is assumed that processing is aborted even in the case of data mismatch at the time of execution of DMPUmatch and Compare instructions. In the present embodiment, it is assumed that processing is allowed to be interrupted by an abort at the time of the fault injection attack.

The instruction MPU is an instruction management function of the MPU 20A. The data MPU is a memory management function of the MPU 20A.

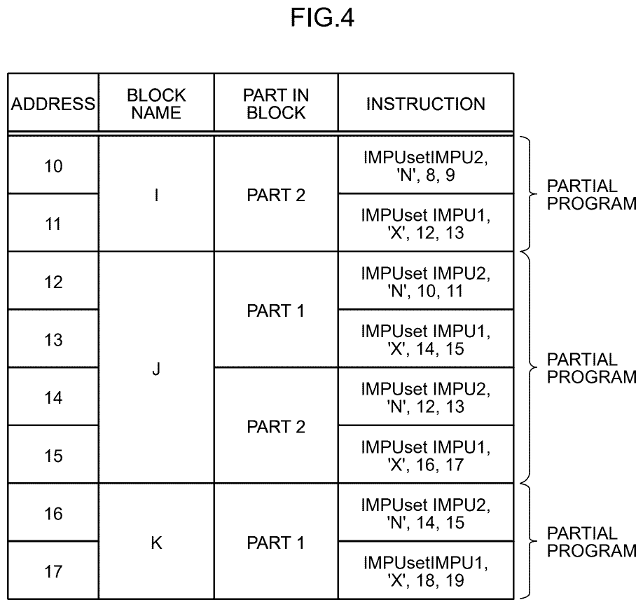

FIG. 4 is a diagram illustrating an example of a sequential execution structure of the partial program executed by the CPU 20. FIG. 4 illustrates a simple configuration in which the CPU 20 uses only an IMPUset instruction which is the virtual instruction to ensure the execution order of the partial program even when there is a fault injection attack on the MCU 10.

For example, the CPU 20 executes the partial programs of Block I, Block J, and Block K in this order. Each block includes two parts of a first half (1st) and a second half (2nd). FIG. 4 illustrates the second half of Block I and the first half of Block K and illustrates both the two parts of Block J.

Each part includes two instructions. For the instruction MPU that has permitted execution of the previous part, the execution is prohibited by maintaining an address range and setting an attribute to “N” with the first instruction. Execution of the next part is enabled by setting the attribute to “X” for a data region corresponding to the next part with the second instruction. The program causes the CPU 20 to repeat such an operation.

In the present embodiment, the CPU 20 implements the countermeasure against the fault injection attack by dividing the program to be executed into functional units and incorporating the functional units into a block structure. Processing corresponding to a content of the block structure corresponds to the unique process described above. As described above, in the example illustrated in FIG. 2, Step S100, Step S104, and Step S110 correspond to each step among unique processes of different partial programs, respectively. The unique process is a conceptual name and does not need to be unique for each block, and the same unique process may be repeatedly used a plurality of times in another partial program.

A case where the fault injection attack on the MCU 10 has occurred during the execution of the program is assumed. For example, a case where the fault injection attack on the MCU 10 has occurred during the execution of Part 1 which is the first half (1st) of Block J is assumed. In this case, since transition of the processing in the same part and to a distant part excluding the previous and following parts is out of a range permitted by the MPU 20A, the processing is interrupted by an abort. Here, the transition indicates that an instruction executed in a different part is different from that in an immediately previously executed part for all of sequential execution of the instructions, execution of a branch instruction included in the instruction, and a result of the fault injection attack.

In a case where the transition of the processing to Part 2 of Block J has occurred during the execution of Part 2 which is the second half (2nd) of Block I, it is possible to detect the transition as an abort by the instruction MPU. In a case where the transition of the processing to Part 1 of Block J has occurred during the execution of Part 1 which is the first half (1st) of Block K, the transition can be detected as an abort by the instruction MPU.

On the other hand, in a case where the fault injection attack has occurred during the execution of Part 1 of Block J, the transition of the processing due to the fault injection attack is not always detected in the same part by such a mechanism. In addition, depending on a timing, the transition of the processing to the previous Part 2 of Block I and the following Part 2 of Block J may not be detected.

That is, with such a simple mechanism, it is possible to prevent one or more parts from being completely skipped for a part that is currently being executed by the CPU 20, or to prevent the transition to a part two or more parts before.

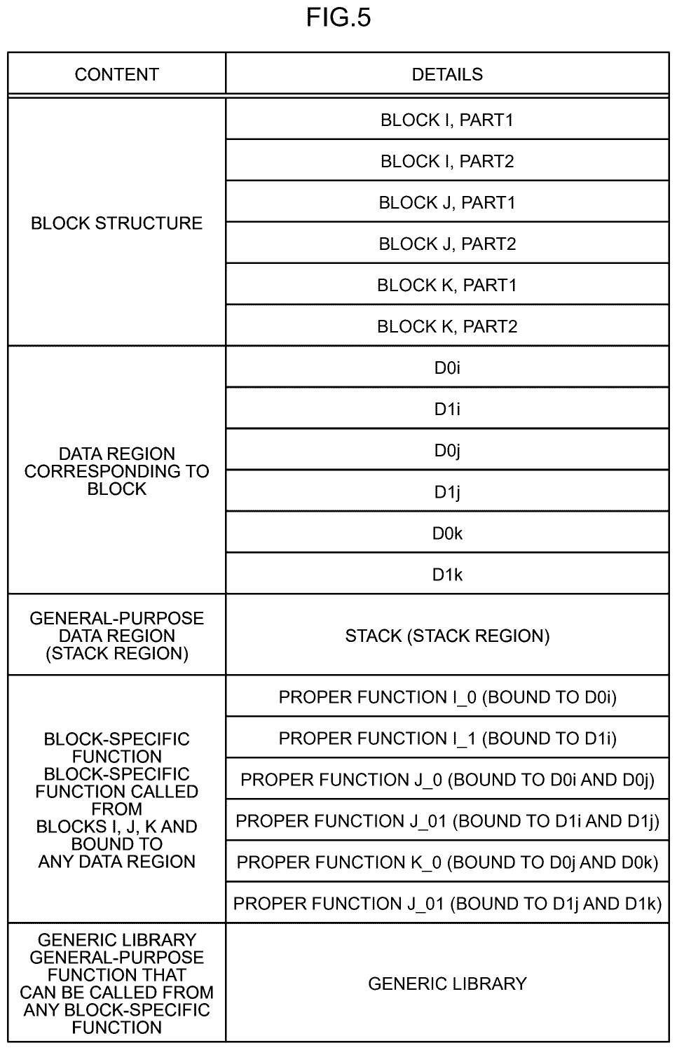

FIG. 5 is an explanatory diagram of an example of a memory layout.

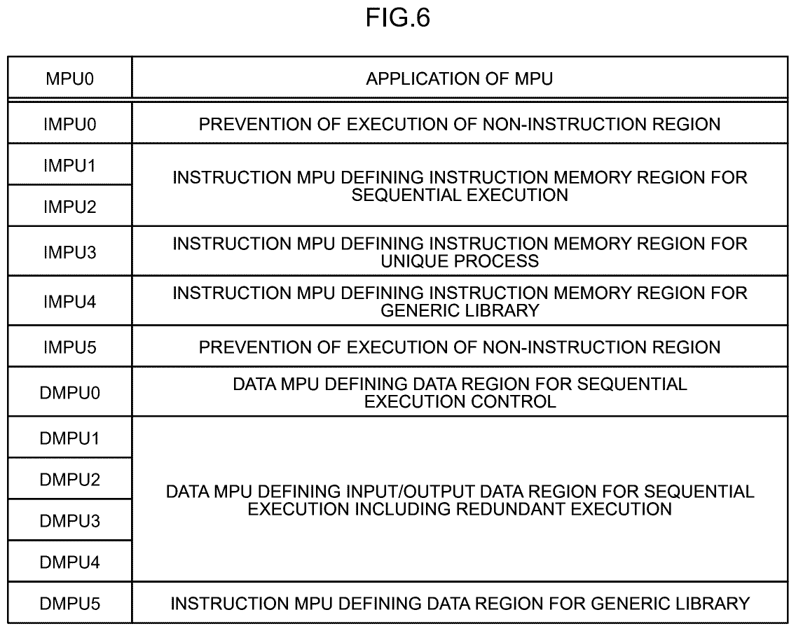

FIG. 6 is an explanatory diagram of a list of application examples of the MPU 20A. Among applications of the MPU 20A illustrated in FIG. 6, the most important applications are IMPU1 to IMPU3 which are the instruction MPUs and DMPU1 to DMPU4 which are the data MPUs.

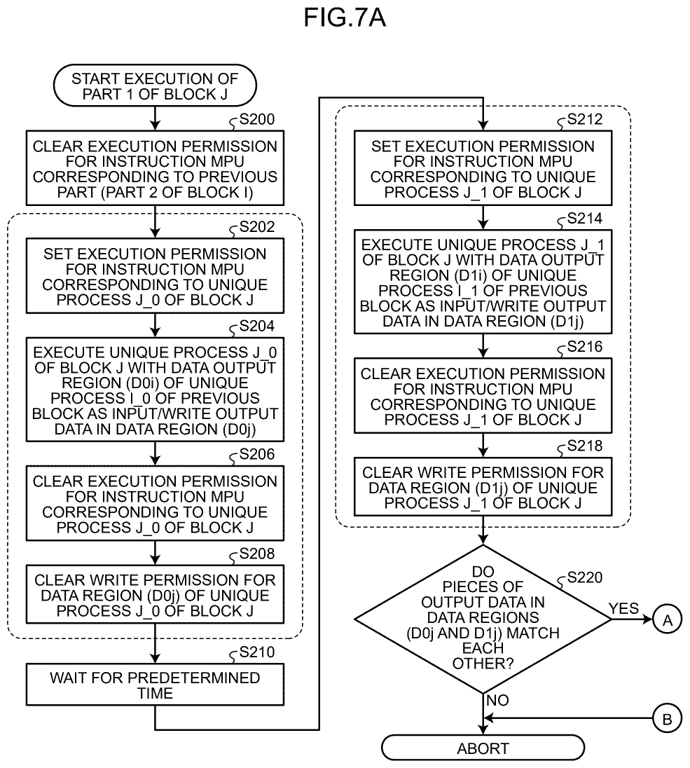

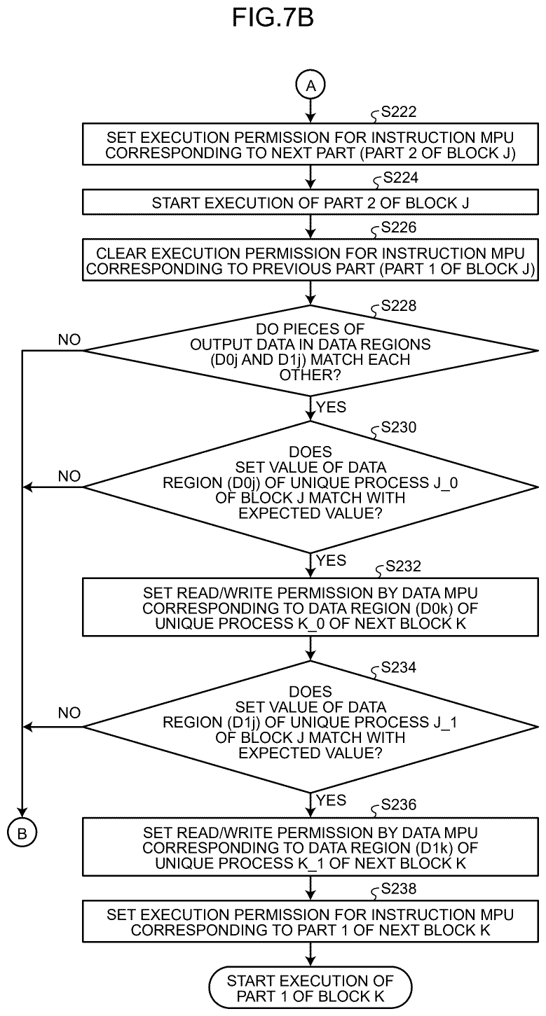

FIG. 7A and FIG. 7B are a flowchart illustrating an example of a flow of information processing executed by the CPU 20 of the present embodiment. FIG. 7A and FIG. 7B illustrate an example in which the CPU 20 executes the partial program (first partial program) including Part 1 of Block J and Part 2 of Block J, and then executes the partial program (second partial program) of Block K. The data region corresponding to each unique process is allocated in advance to each of unique processes. That is, non-overlapping data regions that can be used for each unique process are allocated in advance to each of the unique processes.

Part 1 of Block J executed by the CPU 20 clears execution permission for the instruction MPU corresponding to Part 2 of Block I, which is the previous part (Step S200). By the processing of Step S200, the CPU 20 limits the range of the transition of the processing due to the fault injection attack at the time of completion of the processing of Step S200 to Part 1 of Block J as a partial block that is being processed.

Next, Part 1 of Block J executed by the CPU 20 sets execution permission for the instruction MPU corresponding to unique process J_0 of Block J (Step S202). The unique process J_0 represents unique process associated with the partial program of Block J and represents unique process executed for the first time.

Then, Part 1 of Block J executed by the CPU 20 uses output data stored in a data output region (D0i) of the first unique process I_0 of the previous Block I as an input of the unique process J_0 of Part 1 of Block J. Then, Part 1 of Block J executed by the CPU 20 executes the unique process J_0 of Part 1 of Block J, and writes output data of the unique process J_0 in a data region D0j allocated in advance to the unique process J_0 (Step S204).

Then, Part 1 of Block J executed by the CPU 20 clears execution permission for the instruction MPU corresponding to the unique process J_0 of Part 1 of Block J (Step S206). Part 1 of Block J also clears a generic library in a case where the generic library is used. Hereinafter, a description of MPU processing for the generic library will be omitted.

Then, Part 1 of Block J executed by the CPU 20 clears write permission for the data region D0j to prohibit writing in the data MPU corresponding to the data region D0j of the unique process J_0, and performs setting change such that only reading is possible (Step S208).

Next, Part 1 of Block J executed by the CPU 20 waits for a randomly set predetermined time interval (Step S210).

Next, Part 1 of Block J executed by the CPU 20 sets execution permission for the instruction MPU corresponding to unique process J_1 of Block J (Step S212). The unique process J_1 represents a unique process associated with the partial program of Block J, and represents a unique process executed for the second time.

Then, Part 1 of Block J executed by the CPU 20 uses output data recorded in a data output region (D1i) of a second unique process I_1 of the previous Block I as an input of the unique process J_1 of Part 1 of Block J. Then, Part 1 of Block J executed by the CPU 20 executes the unique process J_1 of Part 1 of Block J with the data output region (D1i) of the unique process I_1 of the previous block as an input, and writes output data of the unique process J_1 in the data region D1j allocated in advance to the unique process J_1 (Step S214).

Then, Part 1 of Block J executed by the CPU 20 clears execution permission for the instruction MPU corresponding to the unique process J_1 of Part 1 of Block J (Step S216).

Then, Part 1 of Block J executed by the CPU 20 clears write permission for the data region D1j to prohibit writing in the data MPU corresponding to the data region D1j of the unique process J_1, and performs setting change such that only reading is possible (Step S218).

Next, Part 1 of Block J executed by the CPU 20 determines whether or not the output data written in the data region D0j and the output data written in the data region D1j match each other (Step S220). In Step S220, it may be determined whether or not digest values of the pieces of output data match each other. The digest value is, for example, a hash value of the output data. That is, in Step S220, it is determined whether or not the output data or the digest value of the output data for each of unique processes J_0 and J_1 recorded in each of the first data regions (D0j and D1j) by the first partial program executed by the CPU 20 match each other.

In a case where it is determined in Step S220 that the pieces of output data do not match each other (Step S220: No), Part 1 of Block J executed by the CPU 20 aborts the processing. On the other hand, in a case where it is determined that the pieces of output data match each other in Step S220 (Step S220: Yes), Part 1 of Block J executed by the CPU 20 sets execution permission for the instruction MPU corresponding to Part 2 of Block J which is the next part (Step S222).

As described above, for Part 1 of Block J executed by the CPU 20, by executing the first unique process J_0 in Steps S202 to S208 and the second unique process J_1 in Steps S212 to S218, redundancy execution is performed for the unique process J associated with the partial program including Part 1 of Block J twice or more. Then, Part 1 of Block J executed by the CPU 20 records each piece of output data that is output for each unique process in each of the data regions D0j and D1j allocated in advance.

Then, in a case where it is determined that the output data written in the data region D0j and the output data written in the data region D1j match each other (Step S220: Yes), Part 1 of Block J executed by the CPU 20 sets execution permission for the instruction MPU corresponding to Part 2 of Block J which is the next part (Step S222).

As such, the CPU 20 of the present embodiment can efficiently reduce the vulnerability to the threat of the fault injection attack by executing the program illustrated in FIG. 7.

In addition, when the unique process is redundantly executed twice or more in Steps S202 to S208 and Steps S212 to S218, Part 1 of Block J executed by the CPU 20 permits execution of the instruction MPU that is an instruction program for executing the unique process before writing (Step S204 and Step S214) the output data in each of the data region D0j and the data region D1j corresponding to each step of unique processes (Step S202 and Step S212). Then, Part 1 of Block J executed by the CPU 20 prohibits the execution of the instruction MPU after the writing (Step S206 and Step S216).

Therefore, the CPU 20 of the present embodiment can suppress execution of an instruction of a part other than the part permitted in the instruction MPU during a period other than execution of a certain unique process by the instruction MPU corresponding to the unique process.

In addition, Part 1 of Block J executed by the CPU 20 executes each of the unique processes J_0 and J_1 in Steps S202 to S208 and Steps S212 to S218 at the randomly set predetermined time interval (Step S210).

Therefore, the MCU 10 of the present embodiment can make the fault injection attack common to the unique processes J_0 and J_1 more difficult.

As described above, the non-overlapping data regions that can be used for each unique process are allocated in advance to each unique process. That is, the unique process associated with each partial program is associated with a specific data region. That is, the unique process associated with each partial program is bound to a specific data region. A function commonly used by the unique processes associated with the respective partial programs may be separately used as a generic library. For the generic library, an instruction image of the generic library can be made common by configuring with the use of the data region given from the unique process associated with each partial program. In the present embodiment, due to a property of redundancy execution of the unique process, it is possible to provide, to the generic library as well, a capability of detecting the fault injection attack without taking a special countermeasure against the fault injection attack.

Furthermore, as described above, the non-overlapping data regions that can be used for each unique process are allocated in advance to each unique process. However, the countermeasure against the fault injection attack such as branch processing is not particularly necessary for each unique process. This is because when the fault injection attack has occurred during the execution of the unique process, it is detected as output data mismatching by the redundancy execution of the unique processes (see Step S220 and Step S228 described below).

In Block K, which is the partial program to be executed subsequently to Block J, only the output data of the unique process J_0 written in the data region D0j allocated in advance to the unique process J_0 and the output data of the unique process J_1 written in the data region D1j allocated in advance to the unique process J_1 are processed as variable inputs. Therefore, even in a case where the fault injection attack has occurred during the execution of the partial program of Block J, it is extremely rare in the fault injection attack of the VFI that the output data of the unique process J_0 written in the data region D0j and the output data of the unique process J_1 written in the data region D1j are completely the same.

In a case where the processing of Block J is very simple, calculation having a property that an error propagates, such as hash calculation, may be processed in parallel. In this case, the MCU 10 can enhance detection capability for the fault injection attack.

The description will be continued by referring back to the flowchart of FIG. 7.

Next, the CPU 20 starts the execution of Part 2 of Block J (Step S224). Part 2 of Block J executed by the CPU 20 does not execute the unique process, and confirms that the unique process in Part 1 of Block J, which is the previous part, has been normally executed by referring to a plurality of evidences.

Specifically, Part 2 of Block J executed by the CPU 20 clears execution permission for the instruction MPU corresponding to Part 1 of Block J, which is the previous part (Step S226). By the processing of Step S226, the CPU 20 limits the range of the transition of the processing due to the fault injection attack at the time of completion of the processing of Step S226 to the inside of Part 2 of Block J as a partial block that is being processed.

Next, Part 2 of Block J executed by the CPU 20 determines whether or not the output data written in the data region D0j and the output data written in the data region D1j match each other (Step S228). In Step S228, it may be determined whether or not digest values of the pieces of output data match each other. The digest value is, for example, a hash value of the output data.

In a case where a negative determination is made in Step S228 (Step S228: No), the CPU 20 aborts the processing. In a case where an affirmative determination is made in Step S228 (Step S228: Yes), the processing proceeds to Step S230.

In Step S230, Part 2 of Block J executed by the CPU 20 determines whether or not the unique process J_0 of Block J has been normally executed (Step S230).

In the present embodiment, Part 2 of Block J executed by the CPU 20 determines whether or not a set value for the data region D0j allocated in advance to the unique process J_0 of Part 1 of Block J of the first partial program matches an expected value for the data region. The set value is an example of an execution evidence. Specifically, Part 2 of Block J executed by the CPU 20 determines whether or not the expected value indicating that “writing is prohibited and only reading is possible” for the data region D0j set for the data MPU corresponding to the data region D0j in Step S208 matches the set value set for the data region D0j.

By executing the determination processing of Step S230, Part 2 of Block J executed by the CPU 20 determines whether or not the unique process J_0 of Block J has been normally executed. By the determination processing, for example, even when the output data written in the data region D0j and the output data written in the data region D1j match each other, the unique process J_0 and the unique process J_1 are not executed, and it is possible to exclude a case where initial values of the data region D0j and the data region D1j simply match each other.

In addition, as described above, the fault injection attack that executes Part 2 of Block J while bypassing all the processes of Part 1 of Block J from Part 2 of Block I is simply unfeasible. However, in a case where the fault injection attack that causes the transition to Step S222 has occurred immediately after the execution of Part 1 of Block J of Step S200, there is a possibility that both the unique process J_0 and the unique process J_1 that have been redundantly executed are bypassed.

However, in the present embodiment, at the time of the execution of Part 2 of Block I executed by the CPU 20, both reading and writing from and in the data region D0i and the data region D1j are permitted. The writing in the data region D0j and the data region D1j is prohibited in Step S204 in which the unique process J_0 and the unique process J_1 are executed, and Step S208 and Step S218 after Step S214. Therefore, in order to match only the MPU setting with the expected value without executing the unique process J_0 and the unique process J_1, the fault injection attack in which a destination of the transition of the processing due to the fault injection attack is accurately specified needs to succeed twice or more, which is probabilistically very difficult. Therefore, the MCU 10 of the present embodiment can reduce the vulnerability to the threat of the fault injection attack.

The description will be continued by referring back to the flowchart of FIG. 7.

In a case where a negative determination is made in Step S230 (Step S230: No), the CPU 20 aborts the processing. In a case where an affirmative determination is made in Step S230 (Step S230: Yes), the processing proceeds to Step S232.

In Step S232, Part 2 of Block J executed by the CPU 20 sets read/write permission for a data region D0k for the data MPU corresponding to the data region D0k allocated to the first unique process K_0 of Block K which is the next partial program (second partial program) (Step S232).

Next, Part 2 of Block J executed by the CPU 20 determines whether or not the unique process J_1 of Block J has been normally executed (Step S234).

Similarly to Step S230, in the present embodiment, Part 2 of Block J executed by the CPU 20 determines whether or not a set value for the data region D1j allocated in advance to the unique process J_1 of Part 1 of Block J of the first partial program as the execution evidence matches an expected value for the data region. Specifically, Part 2 of Block J executed by the CPU 20 determines whether or not the expected value indicating that “writing is prohibited and only reading is possible” for the data region D1j set for the data MPU corresponding to the data region D1j in Step S218 matches the set value set for the data region D1j.

In a case where a negative determination is made in Step S234 (Step S234: No), the CPU 20 aborts the processing. In a case where an affirmative determination is made in Step S234 (Step S234: Yes), the processing proceeds to Step S236.

In Step S236, Part 2 of Block J executed by the CPU 20 sets read/write permission for a data region D1k for the data MPU corresponding to the data region D1k allocated to the second unique process K_1 of Block K which is the next partial program (second partial program) (Step S236).

That is, in a case where Block J, which is an example of the first partial program, makes an affirmative determination in Step S228 and makes an affirmative determination in each of Steps S230 and S234 according to the processing of Steps S232 and S236, execution of Block K, which is an example of the second partial program, is permitted, and reading and writing of the data regions D0k and D1k, which are second data regions allocated in advance to the unique processes K_0 and K_1, which are the second unique processes associated with Block K, by Block K, which is an example of the second partial program, are permitted.

Then, Part 2 of Block J executed by the CPU 20 sets execution permission for the instruction MPU corresponding to Part 1 of Block K which is the partial program to be executed next (Step S238).

That is, Block J, which is an example of the first partial program, permits the execution of Block K, which is an example of the second partial program to be executed subsequently to the first partial program, in a case where an affirmative determination is made in each of steps S220, S228, S230, and S234.

Then, Block K executed by the CPU 20 executes processing similar to Steps S200 to S238 on Block K. In addition, for the partial programs sequentially executed after Block K, it is sufficient if similar steps of processing to those in Steps S200 to S238 are executed for the own partial program.

As described above, the CPU 20 of the MCU 10 (information processing apparatus) of the present embodiment sequentially executes the first partial program (Block J) and the second partial program (Block K). The first partial program causes the CPU 20 to perform redundancy execution of the first unique process associated with the first partial program twice or more (Steps S202 to S208 and Steps S212 to S218). Then, the first partial program causes the CPU 20 to record each piece of output data that is output for each of the first unique processes (unique processes J_0 and J_1) in each of the first data regions (data regions D0j and D1j) allocated in advance to each piece of output data, and permit execution of the second partial program subsequently to the first partial program in a case where the pieces of output data for each first unique process or digest values of the pieces of output data recorded in the first data regions match each other (Step S220 and Step S228) (Step S238).

Therefore, the MCU 10 of the present embodiment can efficiently reduce the vulnerability to the threat of the fault injection attack.

Hitherto, it has been difficult to efficiently reduce the vulnerability to the threat of the fault injection attack.

Specifically, hitherto, cyber security of so-called IoT devices has been a problem, and a security measure is being required for low-cost devices. As for the security measure, a threat of software vulnerability related to communication during operation has attracted attention, and the security measure is not only a function used during operation but also an essential function in a device life cycle such as development, mass production, and returning. On the other hand, there is a demand for appropriate control related to enabling/disabling of a function (internal invasion function) that leads to security infringement when abused during operation. In addition, a security threat includes a proximity-based fault injection attack in addition to a remote attack via communication.

In a relatively high-performance computer system such as a personal computer, a CPU, a volatile memory, and a nonvolatile storage apparatus are often interconnected as separate components. However, in the IoT device, a CPU, a volatile memory, a nonvolatile storage apparatus, and input/output control are provided as an integrated MCU package. For this reason, in the MCU, the attacker cannot freely operate internal information unless special skills and equipment such as package opening are used. However, a threat in which the attacker can steal information from a target MCU or change an operation by using a method of indirect secret information theft or fault injection attack by a side channel attack has been known.

As described above, a primary threat assumed for the MCU 10 of the present embodiment is the latter fault injection attack, particularly, a VFI method of electrically connecting relatively an inexpensive apparatus to a terminal outside the package. As an attack having an effect similar to that of the VFI, non-local electromagnetic fault injection (EMFI) that does not require electrical connection can generate an effect similar to that of the VFI. The measure of the present application is effective for both the VFI and the EMFI.

Hitherto, in an integrated circuit (IC) card or the like, an attack of stealing an encryption key inside a chip using a malfunction caused by the fault injection attack and a countermeasure therefor have been known. However, there is a case where the purpose of the attacker is achieved by reversing a matching comparison result when the function is enabled/disabled based on a simple matching comparison result instead of encryption calculation itself. For example, a case where CPU debugging tool connection is permitted based on a result of matching comparison of a debugging permission request input via communication is considered. The attacker inputs a dummy debug permission request via a communication interface, and verification processing for the request is executed inside the MCU to perform matching comparison for determining verification success and failure. Debugging permission HW setting is performed internally at the time of determination of the verification success, and an external debugger can be connected to the MCU to read or write information in the MCU. Here, it is assumed that the attacker has knowledge in advance about a timing at which matching comparison is performed inside the MCU.

Some related arts have been proposed as methods of mitigating the fault injection attack on software processing including those other than encryption processing. For example, “Fill your Boots: Enhanced Embedded Bootloader Exploits via Fault Injection and Binary Analysis” discloses ten design patterns that are likely to be fragile. However, in the related art, debugging tool connection can be made only by reversing a condition for a single comparison.

As for the vulnerability, it is possible to reduce a success probability of the attack by repeatedly performing the matching comparison a plurality of times.

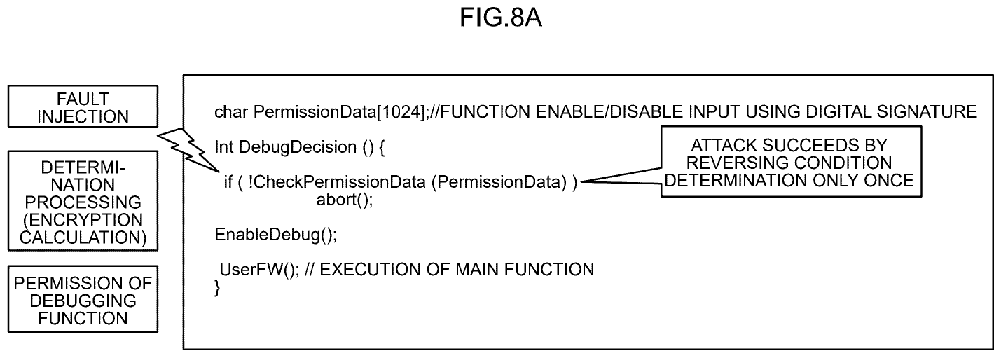

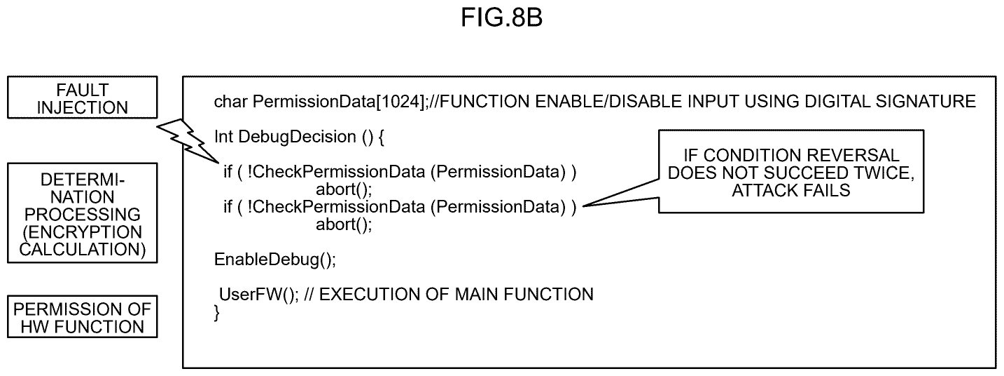

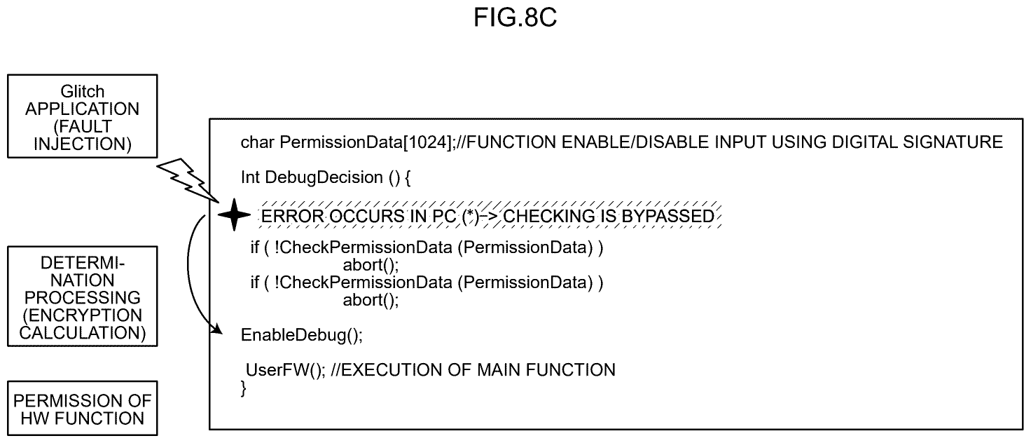

FIG. 8A is an explanatory diagram of an example of the related art. FIG. 8A illustrates a protection target program in the form of a pseudo program. Here, for ease of understanding, the protection target program is illustrated as a high-level linguistic pseudo program, but an actual attack acts on reading and processing of the machine language instruction by the CPU.

FIG. 8A illustrates an operation in which a “CheckPermissionData” function is called in a “DebugDecision” function in response to a preliminarily input debug permission request “PermissionData” to perform signature verification on the data, and the debugging function is permitted and user FW is permitted in a case where the signature verification has succeeded, in the form of a pseudo program.

Here, “PermissionData” is assumed to be data for which the signature verification by the attacker fails. The attacker performs the fault injection attack at a timing of result determination processing executed immediately after completion of “CheckPermissionData” processing. In a case where the signature verification has originally failed, “abort” processing is executed by condition determination, and subsequent program execution is stopped.

However, in a case where the fault injection attack is performed, various abnormalities occur in the instruction executed at that time, such as the machine language instruction being differing instruction, an erroneous register value, erroneous condition determination, and an erroneous program counter value. In the case of the VFI via the power supply, since a local fault injection attack is difficult, the attacker cannot select which effect is to occur. However, it has been reported that a decrease of reversal of condition determination or the like is caused with a certain probability by controlling the timing of the fault injection attack.

In an attack scenario illustrated in FIG. 8A, in condition determination immediately after the execution of the “CheckPermissionData” function, although the processing should be stopped, the processing is continued assuming that the verification has succeeded, the subsequent “EnableDebug” function is executed, connection to the external debugger is permitted, and the user FW is executed in this state. Although this function is originally a function that permits debugging only when permitted, there is a possibility that checking is bypassed by a relatively simple fault injection attack.

In order for the attack to succeed in the attack scenario described above, it is assumed that the program is normally executed at a time point other than a time point of the fault injection attack. In a case where all instructions have been replaced by random abnormal operations independently of the original program, the above attack scenario does not hold. In the above case, “EnableDebug” is executed, and there is no means for the attacker to directly know whether or not the attack has succeeded, and only an indirect method such as successful connection to the external debugger can be used. Due to such restrictions, in the attack scenario effective in the VFI, it is necessary to determine several temporal points at which an attack attempt is made in advance and determine whether or not the attack has succeeded for each attempt.

FIG. 8B is an explanatory diagram of an example of the related art. FIG. 8B illustrates a program for which a simple countermeasure against the attack of FIG. 8A is taken in consideration of the above restriction for the attack scenario.

In FIG. 8A, determination comparison for determining verification success/failure for “CheckPermissionData” is performed twice. By performing the comparison twice, the attack scenario fails if the verification is aborted in the second comparison even in a case where the verification failure is bypassed in the first comparison. According to the report of “Fill your Boots: Enhanced Embedded Bootloader Exploits via Fault Injection and Binary Analysis”, a condition reversal success rate in a simple 8-bit microcomputer is reported to be about 0.1%, and in the case of a more complicated CPU, a probability of condition reversal is generally lower. By repeating the comparison, it is possible to reduce a success probability of the attack scenario by employing redundancy in a time domain.

However, as described above, in the VFI, an influence other than the condition reversal also occurs. It is possible to lower the probability by changing an instruction that does not affect the execution order of the program or by performing the above-described value checking a plurality of times for most of the register values. However, in a case where a value of a program counter (hereinafter referred to as PC) is directly changed, and in a case where a change to an instruction that changes the execution order of the program, such as a jump or a branch, has occurred, the above countermeasure does not function effectively.

FIG. 8C is an explanatory diagram of an example of the related art.

FIG. 8C illustrates a case where the fault injection attack is performed at the time of instruction execution immediately before the execution of “CheckPermissionData”, and the PC becomes an execution start point of “EnableDebug”. Considering that an abnormality of the PC occurs uniformly in a CPU address space such as 32 bits, a possibility that the attack scenario occurs is quite low. However, in a case where the security of encryption currently requiring an effective key length of 100 bits or more, the attack scenario can be a non-negligible threat. In addition, although simple processing in which the debugging function is permitted after the verification has been described, in the case of simple transaction processing (committing data and I/O control of the nonvolatile memory only in a case where a series of processing has finally succeeded) including a plurality of condition determinations and storage of determination results in a storage, evaluation for the attack scenario and introduction of the countermeasure into the program become more complicated.

In addition, as a proximity-based fault injection attack countermeasure in software execution, there is a method of hardware redundancy called a dual core lock system (DCLS) as disclosed in U.S. Pat. No. 5,226,152. However, in the DCLS, since it is necessary to mount two originally necessary CPU cores and perform a comparison operation for each logical clock, there is a problem that the original CPUs and a logic circuit of a comparator are required, an operating frequency is greatly reduced as compared with the case of a single CPU, and a penalty in terms of hardware price and performance is large.

That is, in the related art, it has been difficult to efficiently reduce the vulnerability to the threat of the fault injection attack.

Meanwhile, the CPU 20 of the MCU 10 (information processing apparatus) of the present embodiment sequentially executes the first partial program (Block J) and the second partial program (Block K). The first partial program causes the CPU 20 to perform redundancy execution of the first unique process associated with the first partial program twice or more (Steps S202 to S208 and Steps S212 to S218). Then, the first partial program causes the CPU 20 to record each piece of output data that is output for each of the first unique processes (unique processes J_0 and J_1) in each of the first data regions (data regions D0j and D1j) allocated in advance to each piece of output data, and permit execution of the second partial program subsequently to the first partial program in a case where the pieces of output data of the first unique process or digest values of the pieces of output data recorded in the first data regions match each other (Step S220 and Step S228) (Step S238).

Accordingly, the MCU 10 of the present embodiment can efficiently reduce the vulnerability to the threat of the fault injection attack.

In addition, since the CPU 20 of the MCU 10 of the present embodiment executes the processing of the present embodiment, it is possible to use the existing high functional program library without any fault injection attack countermeasure as it is by handling complicated processing such as the encryption processing and the transaction processing as the unique process.

In addition, the CPU 20 of the MCU 10 of the present embodiment can be executed by a general-purpose single-core CPU having a memory protection function, and can be configured not to require special highly reliable CPU HW such as the dual core lock system (DCLS).

In addition, as described with reference to FIG. 7, the CPU 20 of the MCU 10 of the present embodiment sequentially executes the partial programs, and in a case where the result of the matching determination (Step S220, Step S228, Step S230, and Step S234) indicates mismatching, the processing is aborted. In addition, as described with reference to FIG. 7, in a case where at least one of results of a plurality of matching determinations (Step S220, Step S228, Step S230, and Step S234) indicates mismatching, the CPU 20 of the MCU 10 of the present embodiment aborts the processing upon determination of mismatching.

In addition, as described with reference to FIG. 7, the CPU 20 of the MCU 10 of the present embodiment limits the data that can be directly referred to by the partial program to the output data of the immediately previous partial program executed immediately before. With such limitation, during execution of a certain partial program, it is possible to confirm that execution of the immediately preceding partial program has been completed by multiple checking.

In addition, since the CPU 20 of the MCU 10 of the present embodiment executes the processing illustrated in FIG. 7, it is possible to reduce the vulnerability to the threat of the fault injection attack by effectively combining two elements of redundancy execution of the unique process and utilization of the data MPU with a basic structure of sequential execution by the instruction MPU.

In addition, the CPU 20 of the MCU 10 of the present embodiment executes the processing illustrated in FIG. 7. Therefore, the sequential processing normally proceeds in a case where two values match each other or in a case where an address range defined in the instruction MPU and the data MPU and an access destination match. When the processing proceeds even though the values do not match, the condition is easily reversed in a case where an error occurs in any of registers that store the values due to the fault injection attack. Since the CPU 20 of the MCU 10 of the present embodiment aborts the processing in a case where the values do not match as described above, it is resistant to the threat of the fault injection attack. In addition, in a case where a mismatching condition of the values is included in an algorithm, it is sufficient if the algorithm is implemented in the unique process.

In addition, although the CPU 20 of the MCU 10 of the present embodiment sequentially executes each processing step illustrated in FIG. 7, there can be a case where it is desired to omit a specific processing content in actual processing. In this case, it is possible to cope with such a case by incorporating a procedure of skipping the unique process of a certain block into the unique process. In a case where it is desired to confirm whether or not the processing included in the unique process has been skipped, it is possible to cope with the case by a configuration in which the confirmation result is written in the data region.

The CPU 20 of the MCU 10 of the present embodiment includes a mechanism for blocking processing of a plurality of steps and detecting inconsistency due to the fault injection attack in each of the steps. Therefore, in the MCU 10 of the present embodiment, it is possible to implement the countermeasure against the threat of the fault injection attack without making a special modification for the fault injection attack countermeasure for the unique process and the generic library outside the block structure.

In addition, in the CPU 20 of the MCU 10 of the present embodiment, the fault injection attack countermeasure can be performed not in the special HW such as a dual core lock step but also in a general-purpose MCU including the MPU. The use of the dual core lock step as the fault injection attack countermeasure can be said to be excessive in a case where high malfunction countermeasures are not required for all the applications. However, with the CPU 20 of the MCU 10 of the present embodiment, it is possible to provide the countermeasure against the threat of the fault injection attack for some limited processing.

In addition, since the CPU 20 of the MCU 10 of the present embodiment occupies a plurality of MPUs, it is necessary to adjust the MPU to be used in order to similarly introduce a real-time operating system (RTOS) using the MPU into task implementation. Meanwhile, the MCU 10 of the present embodiment is particularly suitable for a fault injection countermeasure for sequential processing in an environment where all the MPUs before RTOS activation can be freely used, such as secure boot prior to RTOS execution.

The bypass prevention and guarantee of the execution order for the program execution executed by the CPU 20 of the MCU 10 of the present embodiment are a part of the influence of the fault injection attack, and error detection of the register value and the like are also necessary. However, as described above, the error of the register value can be detected by performing checking a plurality of times or performing redundancy execution of the unique process described above and result comparison in complex calculation. Therefore, in the MCU 10 of the present embodiment, it is relatively easy to estimate an influence range and a prevention effect of the countermeasure. In addition, it is generally considered that it is difficult to estimate the influence of the fault injection of the PC and the prevention effect of the countermeasure for a complicated program. However, by the MCU 10 of the present embodiment, it is possible to introduce a countermeasure capable of preventing the influence of the fault injection attack, particularly, the fault injection attack at two or more locations with high probability without changing the software implementation of each unique process, which achieves high usefulness.

In the present embodiment, a mode in which the CPU 20 of the MCU 10, as means for confirming that the unique process has been normally executed, executes confirmation processing for a result of the setting change (Step S208 and Step S218) for the data region D0j and the data region D1j after the execution of the unique process J_0 and the unique process J_1 in Step S204 and Step S214, in Step S230 and Step S234 of Part 2 of Block J, which is the next part, has been described. This is to avoid an unauthorized success of the confirmation processing in a case where the initial value of the data region is 0 and both the unique process J_0 and the unique process J_1 are skipped in the own part due to two or more fault injection attacks.

In a case where there is auxiliary means such as random initialization of the content of the data region by processing by software or hardware at the time of activation of the MCU 10, the confirmation processing can be omitted.

### Second Embodiment

In the above-described embodiment, a mode in which Part 2 of Block J executed by the CPU 20 determines whether or not the unique process J_0 and the unique process J_1 of Block J have been normally executed by determining whether or not the set value for each of the data regions D0j and D1j allocated in advance to each of unique processes matches the expected value for each data region (see Step S230 and Step S234 in FIG. 7) has been described.

In the present embodiment, a mode in which a CPU 20 of an MCU 10 determines whether or not the unique process has been normally executed using a value written in an execution evidence storage region which is a region different from a data region D0j and a data region D1j of output data in a library will be described.

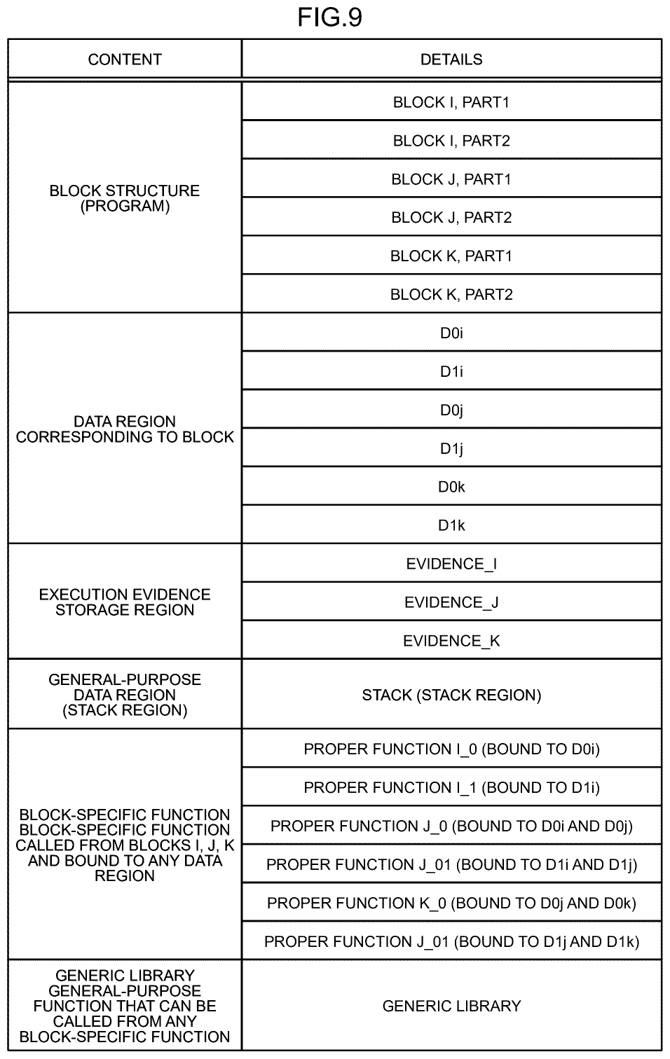

FIG. 9 is an explanatory diagram of an example of a memory layout in the present embodiment. In addition to the memory layout described in the above-described embodiment (see FIG. 5), execution evidence storage regions (Evidence_I, Evidence_J, and Evidence_K) of Blocks I, J, and K are added to the memory layout illustrated in FIG. 9.

The execution evidence storage region is a region different from a data region of the output data such as the data region D0j or the data region D1j in the library, and is a region in which an evidence value is written after the unique process is executed.

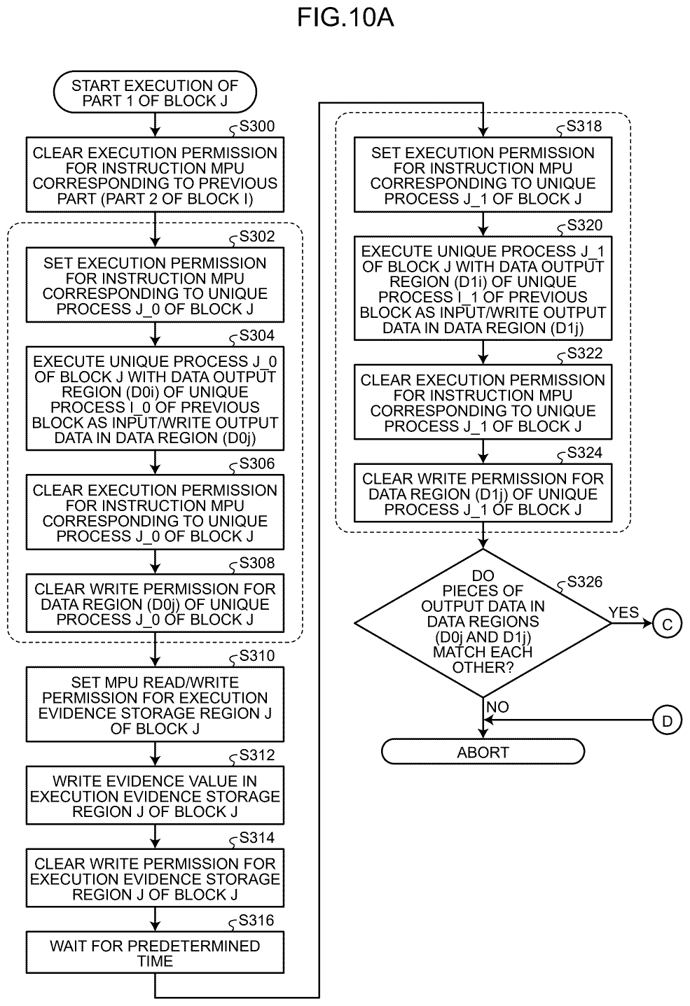

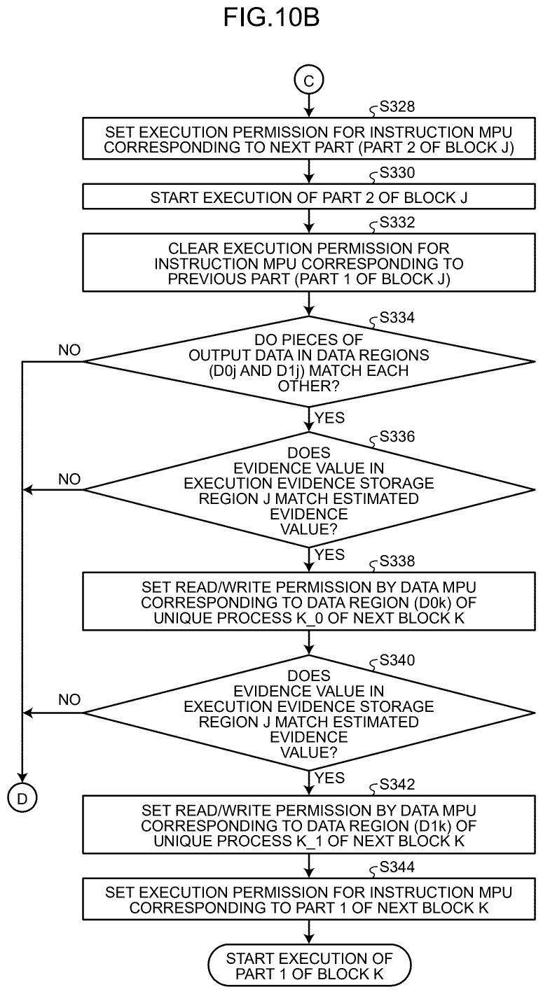

FIG. 10A and FIG. 10B are a flowchart illustrating an example of a flow of information processing executed by the CPU 20 of the present embodiment. The flowchart illustrated in FIG. 10A and FIG. 10B is obtained by adding processing of Steps S310 to S314 to the flowchart illustrated in FIG. 7, and executing processing of Steps S336 and S340 instead of Steps S230 and S234.

Specifically, the CPU 20 of the MCU 10 executes processing of Steps S300 to S308 in a similar manner to Steps S200 to S208.

Specifically, Part 1 of Block J executed by the CPU 20 of the MCU 10 clears execution permission for an instruction MPU corresponding to Part 2 of Block I which is the previous part (Step S300). Next, Part 1 of Block J executed by the CPU 20 sets execution permission for the instruction MPU corresponding to unique process J_0 of Block J (Step S302). Then, Part 1 of Block J executed by the CPU 20 executes the unique process J_0 of Part 1 of Block J, and writes the output data of the unique process J_0 in the data region D0j allocated in advance to the unique process J_0 (Step S304). Then, Part 1 of Block J executed by the CPU 20 clears execution permission for the instruction MPU corresponding to the unique process J_0 of Part 1 of Block J (Step S306). Then, Part 1 of Block J executed by the CPU 20 clears write permission for the data region D0j to prohibit writing in the data MPU corresponding to the data region D0j of the unique process J_0, and performs setting change such that only reading is possible (Step S308).

Next, Part 1 of Block J executed by the CPU 20 sets read/write permission by an MPU 20A for the execution evidence storage region Evidence_J allocated in advance to Block J (Step S310). Then, Part 1 of Block J executed by the CPU 20 writes a predetermined evidence value in the execution evidence storage region Evidence_J (Step S312).

The evidence value may be a predetermined value indicating that the unique process has been executed. For the evidence value, a value unique to each block can be used. For example, the evidence value is a random number value.

Then, Part 1 of Block J executed by the CPU 20 clears write permission for the execution evidence storage region Evidence_J to prohibit writing (Step S314).

Then, the CPU 20 executes processing of Steps S316 to S334 in a similar manner to Steps S210 to S228 of the first embodiment.

Specifically, Part 1 of Block J executed by the CPU 20 waits for a randomly set predetermined time interval (Step S316). Next, Part 1 of Block J executed by the CPU 20 sets execution permission for the instruction MPU corresponding to unique process J_1 of Block J (Step S318). Then, Part 1 of Block J executed by the CPU 20 executes the unique process J_1 of Part 1 of Block J with the data output region (D1i) of the unique process I_1 of the previous block as an input, and writes the output data of the unique process J_1 in the data region D1j allocated in advance to the unique process J_1 (Step S320). Then, Part 1 of Block J executed by the CPU 20 clears execution permission for the instruction MPU corresponding to the unique process J_1 of Part 1 of Block J (Step S322). Then, Part 1 of Block J executed by the CPU 20 clears write permission for the data region D1j to prohibit writing in the data MPU corresponding to the data region D1j of the unique process J_1, and performs setting change such that only reading is possible (Step S324).

Next, Part 1 of Block J executed by the CPU 20 determines whether or not the output data written in the data region D0j and the output data written in the data region D1j match each other (Step S326). In a case where it is determined in Step S326 that the pieces of output data do not match each other (Step S326: No), Part 1 of Block J executed by the CPU 20 aborts the processing. On the other hand, in a case where it is determined that the pieces of output data match each other in Step S326 (Step S326: Yes), Part 1 of Block J executed by the CPU 20 sets execution permission for the instruction MPU corresponding to Part 2 of Block J which is the next part (Step S328).

Next, the CPU 20 starts execution of Part 2 of Block J (Step S330). Part 2 of Block J executed by the CPU 20 clears execution permission for the instruction MPU corresponding to Part 1 of Block J which is the previous part (Step S332). Next, Part 2 of Block J executed by the CPU 20 determines whether or not the output data written in the data region D0j and the output data written in the data region D1j match each other (Step S334). In a case where a negative determination is made in Step S334 (Step S334: No), the CPU 20 aborts the processing. In a case where an affirmative determination is made in Step S334 (Step S334: Yes), the processing proceeds to Step S336.

In Step S336, Part 2 of Block J executed by the CPU 20 determines whether or not the unique process J_0 of Block J has been normally executed (Step S336).

In the present embodiment, Part 2 of Block J executed by the CPU 20 determines whether or not the evidence value written after the execution of the unique process J_0 in an execution evidence storage region J by the processing of Step S312 matches an estimated evidence value (Step S336).

It is assumed that a predetermined value determined in advance is used as the evidence value written in Step S312. In this case, in Step S336, it is sufficient if determination as to whether or not the evidence value written in the execution evidence storage region J matches the predetermined value determined in advance is performed.

In addition, it is assumed that the evidence value written in Step S312 is a random number value. In this case, the CPU 20 generates and holds a random number value before executing the unique process in Step S304, and writes the random number value in the execution evidence storage region J during the processing of Step S312. Then, in Step S336, it is sufficient if determination as to whether or not the evidence value written in the execution evidence storage region J matches the held random number value is performed.

For example, the CPU 20 may generate the random number value each time execution is performed in an initialization procedure that is not included in the flowchart, and is only required to hold the random number value in a predetermined CPU register or memory. Then, it is possible to avoid a malfunction in a case where the previous evidence value remains in the memory by applying a mask value unique to each block thereto.

In a case where a negative determination is made in Step S336 (Step S336: No), the CPU 20 aborts the processing. In a case where an affirmative determination is made in Step S336 (Step S336: Yes), the processing proceeds to Step S338.

In Step S338, similarly to Step S232, Part 2 of Block J executed by the CPU 20 sets read/write permission for a data region D0k for the data MPU corresponding to the data region D0k allocated to the first unique process K_0 of Block K which is the next partial program (second partial program) (Step S338).

Next, in Step S340, Part 2 of Block J executed by the CPU 20 determines whether or not the unique process J_1 of Block J has been normally executed (Step S340).

In the present embodiment, Part 2 of Block J executed by the CPU 20 determines whether or not the evidence value written after the execution of the unique process J_0 in the execution evidence storage region J by the processing of Step S312 matches the estimated evidence value (Step S340). The determination in Step S340 is similar to that in Step S336.

In a case where a negative determination is made in Step S340 (Step S340: No), the CPU 20 aborts the processing. In a case where an affirmative determination is made in Step S340 (Step S340: Yes), the processing proceeds to Step S342.

The CPU 20 executes processing of Steps S342 to S344 in a similar manner to Steps S236 to S238.

Specifically, Part 2 of Block J executed by the CPU 20 sets read/write permission for a data region D1k to the data MPU corresponding to the data region D1k allocated to the second unique process K_1 of Block K which is the next partial program (second partial program) (Step S342). Then, Part 2 of Block J executed by the CPU 20 sets execution permission for the instruction MPU corresponding to Part 1 of Block K which is the partial program to be executed next (Step S344). Then, Block K executed by the CPU 20 executes processing similar to that of Block J on Block K.

Also by the MCU 10 (information processing apparatus) of the present embodiment, it is possible to efficiently reduce the vulnerability to the threat of the fault injection attack similarly to the above-described embodiment.

### Third Embodiment

In the above-described embodiment, as illustrated in FIG. 4, a case where the partial program of each of Block I, Block J, and Block K has a two-part configuration of Part 1 and Part 2 has been described as an example. However, the partial program as each block may have a configuration of three or more parts.

In the present embodiment, a mode in which a partial program as each block has a three-part configuration will be described as an example.

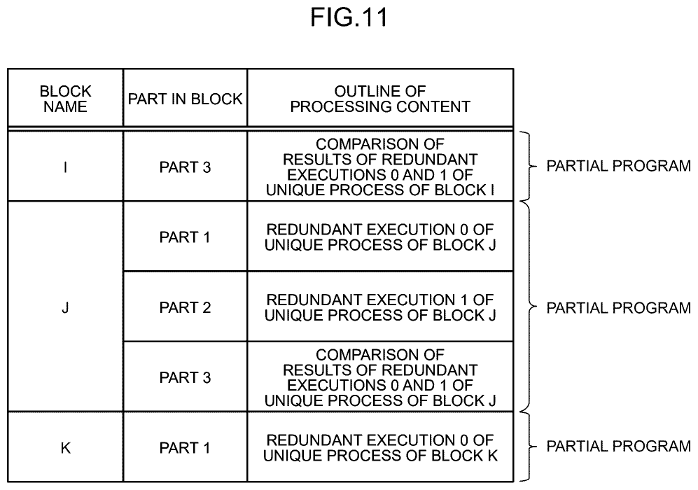

FIG. 11 is a diagram illustrating an example of a sequential execution structure of the partial program executed by a CPU 20. FIG. 11 illustrates a simple configuration in which the CPU 20 uses only an IMPUset instruction which is a virtual instruction to ensure an execution order of the partial program even when there is a fault injection attack on an MCU 10.

For example, the CPU 20 executes the partial programs of Block I, Block J, and Block K in this order. Each block includes three parts. FIG. 11 illustrates only the last part (Part 3) and the first part (Part 1) of Block I and Block K and illustrates all the three parts of Block J.

In the present embodiment, a mode in which, in each block executed by the CPU 20, the first unique process of the own block is executed in Part 1, and the second unique process of the own block is executed in Part 2 will be described.

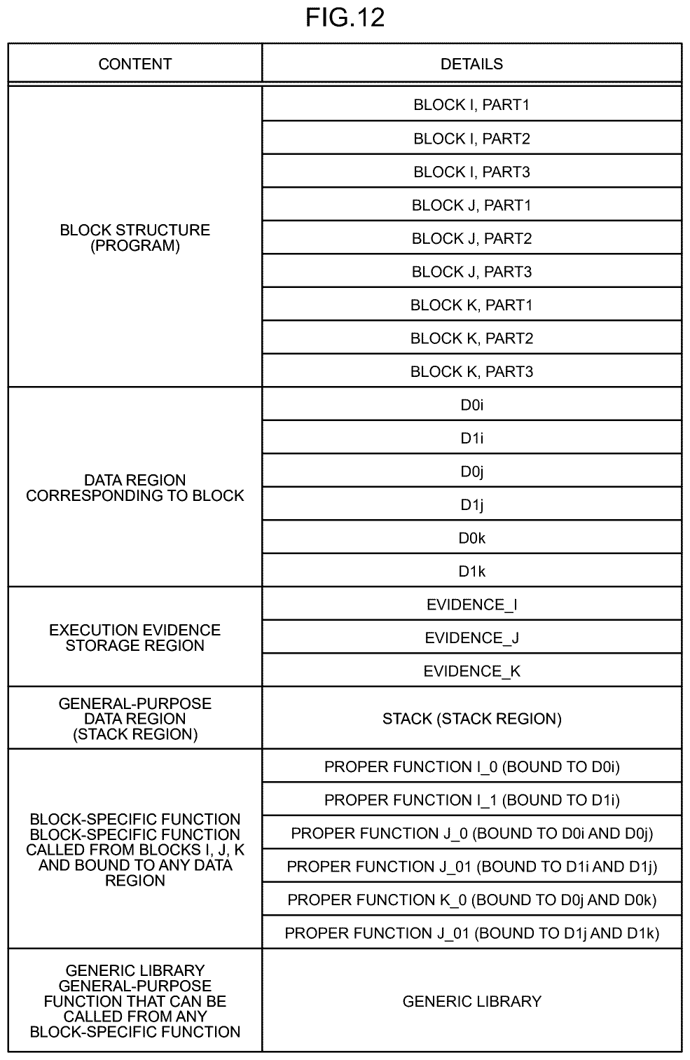

FIG. 12 is an explanatory diagram of an example of a memory layout in the present embodiment. In the memory layout illustrated in FIG. 12, information regarding Part 3 is added to each of Blocks I, J, and K in addition to the memory layout (see FIG. 9) described in the above-described embodiment.

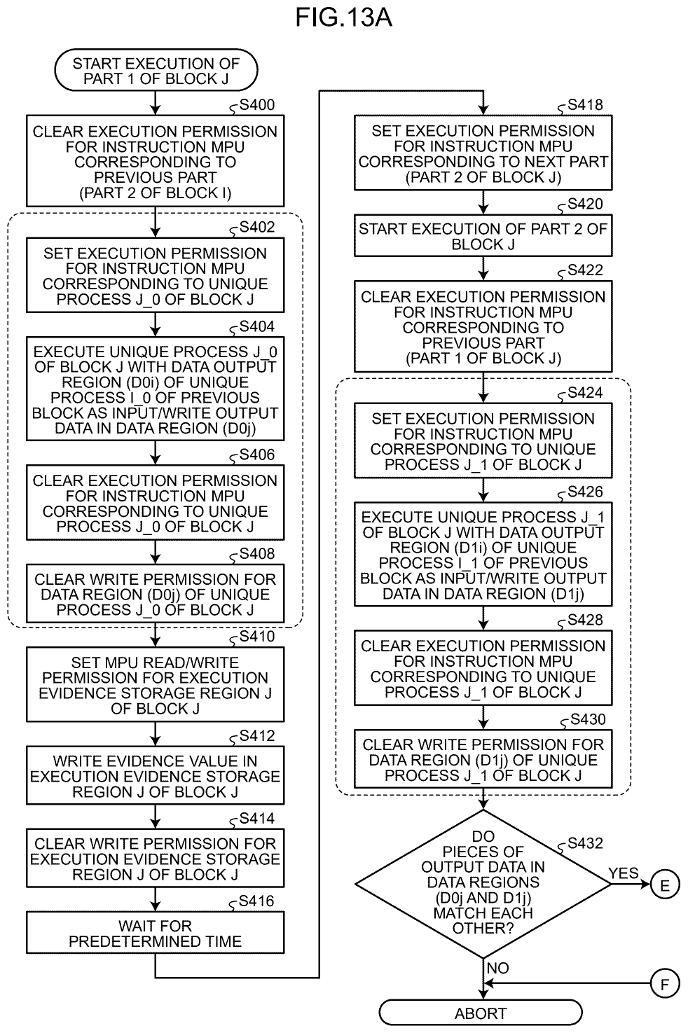

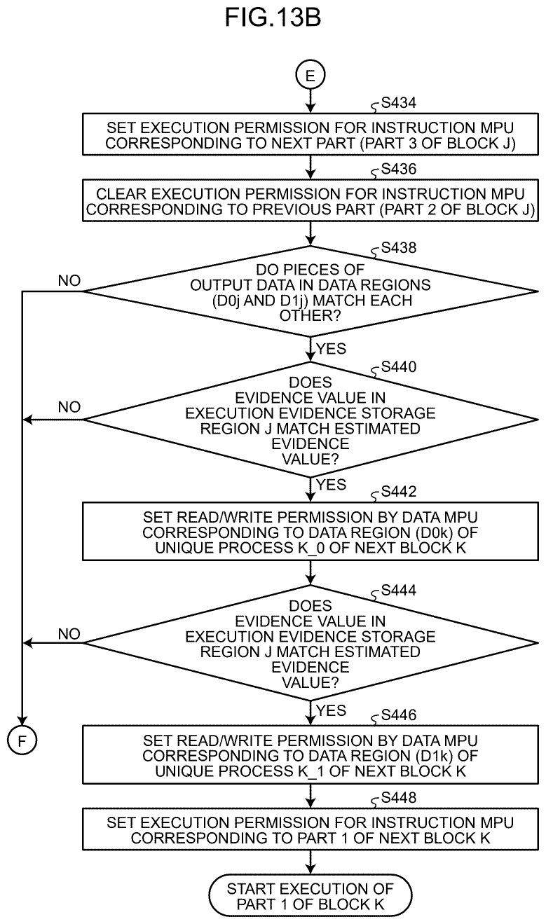

FIG. 13A and FIG. 13B are a flowchart illustrating an example of a flow of information processing executed by the CPU 20 of the present embodiment.

Specifically, the CPU 20 of the MCU 10 executes processing of Steps S400 to S416 in a similar manner to Steps S300 to S316.

Specifically, Part 1 of Block J executed by the CPU 20 of the MCU 10 clears execution permission for an instruction MPU corresponding to Part 2 of Block I which is the previous part (Step S400) Next, Part 1 of Block J executed by the CPU 20 sets execution permission for the instruction MPU corresponding to unique process J_0 of Block J (Step S402) Then, Part 1 of Block J executed by the CPU 20 executes the unique process J_0 of Part 1 of Block J, and writes output data of the unique process J_0 in a data region D0j allocated in advance to the unique process J_0 (Step S404). Then, Part 1 of Block J executed by the CPU 20 clears execution permission for the instruction MPU corresponding to the unique process J_0 of Part 1 of Block J (Step S406) Then, Part 1 of Block J executed by the CPU 20 clears write permission for the data region D0j to prohibit writing in a data MPU corresponding to the data region D0j of the unique process J_0, and performs setting change such that only reading is possible (Step S408).

Next, Part 1 of Block J executed by the CPU 20 sets read/write permission by an MPU 20A for an execution evidence storage region Evidence_J allocated in advance to Block J (Step S410). Then, Part 1 of Block J executed by the CPU 20 writes a predetermined evidence value in the execution evidence storage region Evidence_J (Step S412). Then, Part 1 of Block J executed by the CPU 20 clears write permission for the execution evidence storage region Evidence_J to prohibit writing (Step S414). Then, Part 1 of Block J executed by the CPU 20 waits for a randomly set predetermined time interval (Step S416).

Next, Part 1 of Block J executed by the CPU 20 sets execution permission for the instruction MPU corresponding to Part 2 of Block J which is the next part (Step S418). Then, the CPU 20 starts execution of Part 2 of Block J (Step S420). Part 2 of Block J executed by the CPU 20 clears execution permission for the instruction MPU corresponding to Part 1 of Block J which is the previous part (Step S422) The steps of processing of Steps S418, S420, and S422 are similar to those of Steps S328, S330, and S332, respectively.

Next, the CPU 20 executes processing of Steps S424 to S432. The steps of processing of Steps S424 to S432 are similar to those of Steps S318 to S326 except that Part 2 of Block J executes the processing instead of Part 1 of Block J.

Specifically, Part 2 of Block J executed by the CPU 20 sets execution permission for the instruction MPU corresponding to unique process J_1 of Block J (Step S424). Then, Part 2 of Block J executed by the CPU 20 executes the unique process J_1 of Block J with the data output region (D1i) of the unique process I_1 of the previous block as an input, and writes the output data of the unique process J_1 in a data region D1j allocated in advance to the unique process J_1 (Step S426). Then, Part 2 of Block J executed by the CPU 20 clears execution permission for the instruction MPU corresponding to the unique process J_1 of Block J (Step S428). Then, Part 2 of Block J executed by the CPU 20 clears write permission for the data region D1j to prohibit writing in the data MPU corresponding to the data region D1j of the unique process J_1, and performs setting change such that only reading is possible (Step S430).

Next, Part 2 of Block J executed by the CPU 20 determines whether or not the output data written in the data region D0j and the output data written in the data region D1j match each other (Step S432). In a case where it is determined in Step S432 that the pieces of output data do not match each other (Step S432: No), Part 2 of Block J executed by the CPU 20 aborts the processing. On the other hand, in a case where it is determined that the pieces of output data match each other in Step S432 (Step S432: Yes), Part 2 of Block J executed by the CPU 20 proceeds to Step S434.

In Step S434, Part 2 of Block J executed by the CPU 20 sets execution permission for the instruction MPU corresponding to Part 3 of Block J which is the next part (Step S434). Then, Part 2 of Block J executed by the CPU 20 clears execution permission for the instruction MPU corresponding to Part 2 of Block J which is the previous part (Step S436).

Next, the CPU 20 executes processing of Steps S438 to S448 in a similar manner to Steps S334 to S344.

Specifically, Part 3 of Block J executed by the CPU 20 determines whether or not the output data written in the data region D0j and the output data written in the data region D1j match each other (Step S438). In a case where a negative determination is made in Step S438 (Step S438: No), the CPU 20 aborts the processing. In a case where an affirmative determination is made in Step S438 (Step S438: Yes), the processing proceeds to Step S440.

In Step S440, Part 3 of Block J executed by the CPU 20 determines whether or not the unique process J_0 of Block J has been normally executed (Step S440). In Step S440, for example, Part 2 of Block J executed by the CPU 20 determines whether or not the evidence value written after the execution of the unique process J_0 in an execution evidence storage region J by the processing of Step S412 matches an estimated evidence value.

In a case where a negative determination is made in Step S440 (Step S440: No), the CPU 20 aborts the processing. In a case where an affirmative determination is made in Step S440 (Step S440: Yes), the processing proceeds to Step S442.

In Step S442, Part 3 of Block J executed by the CPU 20 sets read/write permission for a data region D0k for the data MPU corresponding to the data region D0k allocated to the first unique process K_0 of Block K which is the next partial program (second partial program) (Step S442).

Next, in Step S444, Part 3 of Block J executed by the CPU 20 determines whether or not the unique process J_1 of Block J has been normally executed (Step S444). In Step S444, for example, Part 3 of Block J executed by the CPU 20 determines whether or not the evidence value written after the execution of the unique process J_0 in the execution evidence storage region J by the processing of Step S412 matches the estimated evidence value (Step S444). The determination in Step S444 is similar to that in Step S440.

In a case where a negative determination is made in Step S444 (Step S444: No), the CPU 20 aborts the processing. In a case where an affirmative determination is made in Step S444 (Step S444: Yes), the processing proceeds to Step S446.

The CPU 20 executes processing of Steps S446 to S448 in a similar manner to Steps S342 to S344.

Specifically, Part 3 of Block J executed by the CPU 20 sets read/write permission for a data region D1k for the data MPU corresponding to the data region D1k allocated to the second unique process K_1 of Block K which is the next partial program (second partial program) (Step S446). Then, Part 3 of Block J executed by the CPU 20 sets execution permission for the instruction MPU corresponding to Part 1 of Block K which is the partial program to be executed next (Step S448). Then, Block K executed by the CPU 20 executes processing similar to that of Block J on Block K.

As described above, in the present embodiment, the first partial program causes the CPU 20 to execute the unique process after execution permission is obtained for each of unique processes of twice or more redundancy executions, and clear the execution permission for the unique process after the unique process is executed (Step S418 and Step S448).

Also by the MCU 10 (information processing apparatus) of the present embodiment, it is possible to efficiently reduce the vulnerability to the threat of the fault injection attack similarly to the above-described embodiment.

The determination processing in Step S438, the determination processing in Step S440, and the determination processing in Step S444 executed by Part 3 of Block J executed by the CPU 20 of the present embodiment may be further divided into individual parts and executed.

In the MCU 10 of the above-described embodiment, the CPU 20 reads the program from the nonvolatile memory 24, the nonvolatile memory 23, or the like onto the volatile memory 25 and executes the program, so that each processing described above is implemented on a computer.

The program for executing each processing described above executed by the MCU 10 of the above-described embodiment may be stored in a hard disk drive (HDD). In addition, the program for executing each processing described above executed by the MCU 10 of the above-described embodiment may be provided by being incorporated in the nonvolatile memory 23 in advance.

Furthermore, the program for executing the above-described processing executed by the MCU 10 of the above-described embodiment may be stored in a computer-readable storage medium such as a CD-ROM, a CD-R, a memory card, a digital versatile disc (DVD), or a flexible disk (FD) as a file in an installable format or an executable format, and may be provided as a computer program product. In addition, the program for executing the above-described processing executed by the MCU 10 of the above-described embodiment may be stored in the computer connected to a network such as the Internet and may be provided by being downloaded via the network. In addition, the program for executing the above-described processing executed by the MCU 10 of the above-described embodiment may be provided or distributed via a network such as the Internet.

Although the embodiments of the present invention have been described above, the above-described embodiments have been presented as examples and are not intended to limit the scope of the invention. These novel embodiments can be implemented in various other forms, and various omissions, substitutions, and changes can be made without departing from the gist of the invention. These embodiments and modified examples thereof are included in the scope and gist of the invention, and are included in the invention described in the claims and the equivalent scope thereof.

In addition, the unique process in the present embodiment can include processing related to important determination that needs to be prevented from unauthorized use, such as access to the inside of the MCU and permission to update the internal information in the MCU and an MCU application device. Examples of the important determination include determination of activation (enabling) of a software debugging function and a hardware test function which are necessary for operations such as development, mass production, returning (handling of defects), and software update but are inactivated (disabled) during normal operation. In addition, the MCU 10 of the present embodiment can also be used for the purpose of reliably disabling some functions that are required to be disabled under legal regulations under use conditions for a user, such as a function corresponding to a radio frequency or a medical device that is not permitted in a certain country.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a central processing unit (CPU) configured to sequentially execute a first partial program and a second partial program, wherein
the first partial program causes the CPU to:
perform redundancy execution of a unique process associated with the first partial program twice or more and record each piece of output data that is output for each unique process in a first data region allocated in advance to the each piece of output data, and
permit execution of the second partial program subsequently to the first partial program
in a case where pieces of output data or digest values of the pieces of output data for the each unique process recorded in the first data regions match each other.

2. The information processing apparatus according to claim 1, wherein
the first partial program causes the CPU to:
permit execution of the second partial program and permit reading and writing from and in a second data region allocated in advance to a second unique process associated with the second partial program by the second partial program
in a case where the pieces of output data or the digest values of the pieces of output data for the each unique process recorded in the first data regions match each other.

3. The information processing apparatus according to claim 1, wherein
the first partial program causes the CPU to:
determine whether or not the unique process has been normally executed based on an execution evidence of the unique process, and permit execution of the second partial program in a case where it is determined that the unique process has been normally executed.

4. The information processing apparatus according to claim 3, wherein
in a case where it is determined that a set value for the first data region of the first partial program as the execution evidence matches an expected value for the first data region, it is determined that the unique process has been normally executed.

5. The information processing apparatus according to claim 3, wherein
in a case where it is determined that an evidence value written after the execution of the unique process in an execution evidence storage region, which is a different region in a library from a data region of the output data, matches an estimated evidence value, it is determined that the unique process has been normally executed.

6. The information processing apparatus according to claim 5, wherein
the evidence value is a predetermined value indicating that the unique process has been executed.

7. The information processing apparatus according to claim 5, wherein
the evidence value is a random number value.

8. The information processing apparatus according to claim 1, wherein
the unique process is a program lacking a fault injection attack countermeasure and is callable from each of the first partial program and the second partial program.

9. The information processing apparatus according to claim 1, wherein
the CPU aborts processing in a case where a result of matching determination indicates mismatching.

10. The information processing apparatus according to claim 1, wherein
in a case where at least one of a plurality of determination results indicates mismatching,
the CPU aborts processing upon determination of mismatching.

11. The information processing apparatus according to claim 1, wherein
the first partial program causes the CPU to:
permit execution of an instruction program for executing the unique process before the output data is written in the first data region, and
prohibit execution of the instruction program after writing.

12. The information processing apparatus according to claim 1, wherein
the first partial program causes the CPU to:
execute the unique process after execution permission is obtained for each of unique processes of twice or more redundancy executions, and clear the execution permission for the unique process after the unique process is executed.

13. The information processing apparatus according to claim 1, wherein
the first partial program causes the CPU to execute a plurality of unique processes at a randomly set predetermined time interval.

14. An information processing method executed by a computer, the method comprising:
performing, with a first partial program, redundancy execution of a unique process associated with the first partial program twice or more and recording each piece of output data that is output for each unique process in a first data region allocated in advance to the each piece of output data, the first partial program and a second partial program being sequentially executed; and
permitting, with the first partial program, execution of the second partial program subsequently to the first partial program
in a case where pieces of output data or digest values of the pieces of output data for the each unique process recorded in the first data regions match each other.

15. A computer program product having a non-transitory computer readable medium including instructions stored thereon, wherein the instructions, when executed by a computer, cause the computer to execute:
performing redundancy execution of a unique process associated with a first partial program twice or more and recording each piece of output data that is output for each unique process in a first data region allocated in advance to the each piece of output data, the first partial program and a second partial program being sequentially executed; and
permitting execution of the second partial program subsequently to the first partial program
in a case where pieces of output data or digest values of the pieces of output data for the each unique process recorded in the first data regions match each other.
